(19) United States
(12) Patent Application Publication
(10) Pub. No.: US 2022/0324705 A1
(43) Pub. Date: Oct. 13, 2022

(54) HYDROGEN PRODUCTION APPARATUS

(71) Applicant: IHI Corporation, Tokyo (JP)

(72) Inventors: Yosuke TSUBOI, Tokyo (JP); Hironobu FUJIYOSHI, Tokyo (JP); Yuping LIU, Tokyo (JP)

(73) Assignee: IHI Corporation, Tokyo (JP)

(21) Appl. No.: 17/843,100

(22) Filed: Jun. 17, 2022

Related U.S. Application Data
(63) Continuation of application No. PCT/JP2021/003762, filed on Feb. 2, 2021.

(30) Foreign Application Priority Data
Mar. 19, 2020 (JP) 2020-049291

(51) Int. Cl. C01B 3/26; C01B 3/50

(52) U.S. Cl. CPC C01B 3/26; C01B 3/50; C01B 2203/049; C01B 2203/1235; C01B 2203/82

(57) ABSTRACT

A hydrogen production apparatus includes a heating furnace that burns fuel supplied by a fuel supply unit and heats catalyst particles, a cyclone that is connected to a downstream side of the heating furnace and separates the catalyst particles and a combustion exhaust gas, and a thermal decomposition furnace including a storage tank that stores the catalyst particles separated by the cyclone and a raw material gas introduction unit that introduces a raw material gas containing at least hydrocarbon from a lower portion of the storage tank.

### CROSS REFERENCE TO RELATED APPLICATIONS

This application is a continuation application of International Application No. PCT/JP2021/003762, filed on Feb. 2, 2021, which claims the benefit of priority under Japanese Patent Application No. 2020-049291 filed on Mar. 19, 2020, and the entire content of which is hereby incorporated by reference.

### BACKGROUND ART

### Technical Field

The present disclosure relates to a hydrogen production apparatus.

### Related Art

As a technique for producing hydrogen, a technique for steam reforming of hydrocarbon such as methane is known. However, in the steam reforming, carbon dioxide is generated in the process of producing hydrogen. Thus, it is conceivable to produce hydrogen that does not discharge carbon dioxide by thermally decomposing hydrocarbon to produce carbon as a solid.

As a technique for thermally decomposing hydrocarbon, an apparatus including a reaction furnace, a raw material gas supply source, and a heating section is disclosed (for example, Patent Literature 1), and the reaction furnace accommodates a catalyst. The raw material gas supply source supplies hydrocarbon to the reaction furnace. The heating section is provided around the reaction furnace and heats the inside of the reaction furnace.

### CITATION LIST

### Patent Literature

Patent Literature 1: Japanese Patent No. 5862559

### SUMMARY

### Technical Problem

A thermal decomposition reaction of hydrocarbon efficiently proceeds at 800° C. or higher by using a catalyst. However, since the thermal decomposition reaction of hydrocarbon is an endothermic reaction, it is necessary to supply heat from the outside. Thus, in the technique of heating the reaction furnace from the outside as in Patent Literature 1, it is necessary to heat a furnace wall of the reaction furnace to 1000° C. or higher in order to heat the inside of the reaction furnace to 800° C. or higher. Thus, it is necessary to form the reaction furnace with a material having heat resistance of 1000° C. or higher, and there is a problem that the cost required for the reaction furnace increases.

Thus, in view of such problems, an object of the present disclosure is to provide a hydrogen production apparatus capable of thermally decomposing hydrocarbon at low cost.

### Solution to Problem

In order to solve the above problems, a hydrogen production apparatus according to an aspect of the present disclosure includes a heating furnace that burns fuel supplied by a fuel supply unit and heats catalyst particles, a cyclone that is connected to a downstream side of the heating furnace and separates the catalyst particles and a combustion exhaust gas, and a thermal decomposition furnace including a storage tank that stores the catalyst particles separated by the cyclone and a raw material gas introduction unit that introduces a raw material gas containing at least hydrocarbon from a lower portion of the storage tank.

The hydrogen production apparatus may further include a hydrogen separation unit that separates hydrogen from a mixed gas delivered from the storage tank, and the fuel supply unit may supply, as the fuel, the hydrogen separated by the hydrogen separation unit to the heating furnace.

The hydrogen production apparatus may further include a hydrogen separation unit that separates hydrogen from a mixed gas delivered from the storage tank, and the fuel supply unit may supply, as the fuel, the mixed gas obtained after the hydrogen is separated by the hydrogen separation unit to the heating furnace.

The hydrogen production apparatus may further include a carbon recovery unit that removes solid carbon from the mixed gas delivered from the storage tank, and the fuel supply unit may supply, as the fuel, the mixed gas from which the solid carbon has been removed to the heating furnace.

The storage tank may include a particle introduction port through which the catalyst particles separated by the cyclone are guided, a first delivery port through which the mixed gas generated in the storage tank is delivered, and a second delivery port which is provided between the particle introduction port and the first delivery port and through which the mixed gas generated in the storage tank is delivered, and the fuel supply unit may supply, as the fuel, the mixed gas delivered from the storage tank to the heating furnace through the second delivery port.

The hydrogen production apparatus may further include a partition plate which is provided in the storage tank and partitions the inside of the storage tank into a first chamber in which the first delivery port is provided and a second chamber in which the second delivery port is provided.

The hydrogen production apparatus may further include a first heat exchange unit that exchanges heat between the combustion exhaust gas separated by the cyclone and the oxidant, and an oxidant supply unit that supplies the oxidant heat-exchanged by the first heat exchange unit to the heating furnace.

The hydrogen production apparatus may further include a second heat exchange unit that exchanges heat between the mixed gas delivered from the storage tank and the raw material gas, and the raw material gas introduction unit may introduce the raw material gas heat-exchanged by the second heat exchange unit into the storage tank.

### Effects of Disclosure

According to the present disclosure, it is possible to thermally decompose hydrocarbon at low cost.

### BRIEF DESCRIPTION OF DRAWINGS

FIG. 1 is a view for explaining a hydrogen production apparatus according to a first embodiment.

FIG. 2 is a view for explaining a purification apparatus according to the first embodiment.

FIG. 3 is a view for explaining a fuel supply unit according to a first modification.

FIG. 4 is a view for explaining the fuel supply unit according to a second modification.

FIG. 5 is a view for explaining a heating furnace, a cyclone, and a thermal decomposition furnace according to a third modification.

FIG. 6 is a view for explaining a hydrogen production apparatus according to a second embodiment.

FIG. 7 is a view for explaining a purification apparatus according to the second embodiment.

FIG. 8 is a view for explaining a relationship between a reaction time in which methane as a raw material gas is passed through catalyst particles and a gas generation amount in a storage tank.

### DESCRIPTION OF EMBODIMENTS

Hereinafter, embodiments of the present disclosure will be described in detail with reference to the accompanying drawings. Sizes, materials, specific values, and any other factors illustrated in respective embodiments are illustrative for easier understanding of the disclosure, and are not intended to limit the scope of the disclosure unless otherwise specifically stated. Throughout the present description and the drawings, elements having substantially the same function and configuration are denoted with the same reference numerals to avoid any redundant description. Further, elements that are not directly related to the disclosure are unillustrated in the drawings.

### First Embodiment: Hydrogen Production Apparatus 100

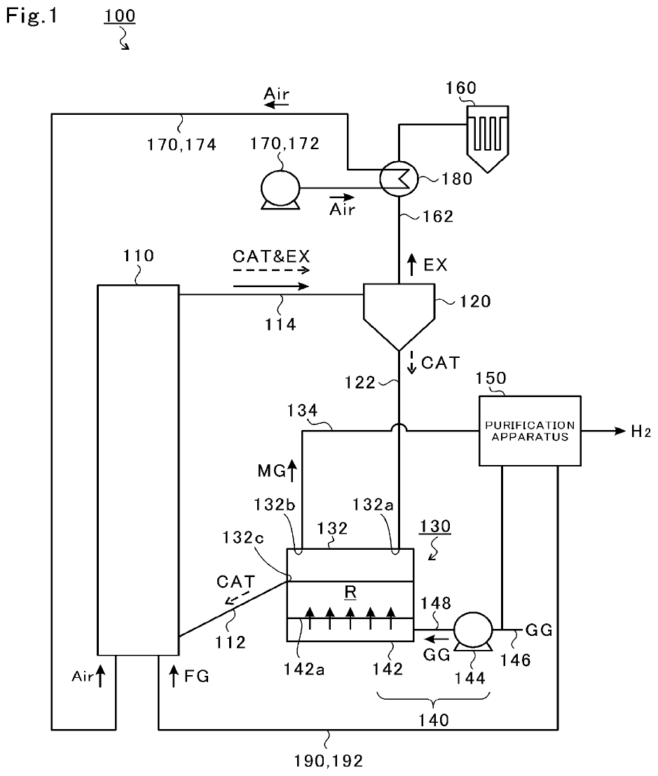

FIG. 1 is a view for explaining a hydrogen production apparatus 100 according to a first embodiment. As illustrated in FIG. 1, the hydrogen production apparatus 100 includes a heating furnace 110, a first pipe 112, a second pipe 114, a cyclone 120, a communication pipe 122, a thermal decomposition furnace 130, a first delivery pipe 134, a purification apparatus 150, a dust removal apparatus 160, a third pipe 162, an oxidant supply unit 170, a first heat exchange unit 180, and a fuel supply unit 190. In FIG. 1, solid arrows indicate a flow of gas. In FIG. 1, a broken line arrow indicates a flow of catalyst particles CAT.

The heating furnace 110 has a tubular shape. The first pipe 112 connects a lower portion of the heating furnace 110 and the thermal decomposition furnace 130 (side surface of a storage tank 132) described later. The first pipe 112 is provided with a loop seal (not illustrated). The catalyst particles CAT are introduced into the heating furnace 110 from the thermal decomposition furnace 130 through the first pipe 112 and the loop seal.

The catalyst particle CAT is a catalyst that promotes a thermal decomposition reaction represented by the following formula (1).

CH₄→C+2H₂ Formula (1)

The catalyst particle CAT is, for example, an iron-based catalyst (iron, iron ore). A particle size of the catalyst particles CAT is, for example, 50 μm or more and 1000 μm or less, and preferably 100 μm or more and 300 μm or less.

The heating furnace 110 burns fuel FG, supplied by the fuel supply unit 190 described later, with air to heat the catalyst particles CAT to about 900° C. The second pipe 114 connects an upper portion of the heating furnace 110 and the cyclone 120 to be described later. The catalyst particles CAT and a combustion exhaust gas EX heated in the heating furnace 110 are delivered to the cyclone 120 through the second pipe 114.

The cyclone 120 is provided above the thermal decomposition furnace 130. The cyclone 120 is connected to a downstream side of the heating furnace 110 via the second pipe 114. The cyclone 120 performs solid-gas separation of a mixture of the catalyst particles CAT and the combustion exhaust gas EX introduced from the heating furnace 110 through the second pipe 114.

The communication pipe 122 connects a bottom of the cyclone 120 and the thermal decomposition furnace 130 (storage tank 132). The communication pipe 122 is provided with a loop seal (not illustrated). The high-temperature catalyst particles CAT separated by the cyclone 120 are introduced into the thermal decomposition furnace 130 through the communication pipe 122 and the loop seal.

The thermal decomposition furnace 130 is, for example, a bubble fluidized bed (bubbling fluidized bed) furnace. In the thermal decomposition furnace 130, the high-temperature catalyst particles CAT introduced from the cyclone 120 are fluidized by the raw material gas GG. The raw material gas GG contains at least hydrocarbon (for example, methane). The raw material gas GG is, for example, liquefied natural gas (LNG). Hereinafter, methane is taken as an example of hydrocarbon.

Specifically, the thermal decomposition furnace 130 includes the storage tank 132 and a raw material gas introduction unit 140. The storage tank 132 is a container that stores the high-temperature catalyst particles CAT separated by the cyclone 120. On an upper surface of the storage tank 132, a particle introduction port 132a and a first delivery port 132b are provided. The first delivery port 132b is provided downstream of the particle introduction port 132a in a flow direction of the catalyst particles CAT.

The communication pipe 122 is connected to the particle introduction port 132a. The first delivery pipe 134 is connected to the first delivery port 132b. A particle discharge port 132c is provided on a side surface of the storage tank 132. The first pipe 112 is connected to the particle discharge port 132c. A bottom surface of the storage tank 132 is formed of a breathable dispersion plate 142a.

The raw material gas introduction unit 140 introduces the raw material gas GG from a lower portion of the storage tank 132. In the present embodiment, the raw material gas introduction unit 140 includes a wind box 142 and a blower 144. The wind box 142 is provided below the storage tank 132. An upper portion of the wind box 142 is formed of the dispersion plate 142a. In other words, the dispersion plate 142a partitions the storage tank 132 and the wind box 142. The blower 144 supplies the raw material gas GG to the wind box 142. A suction side of the blower 144 is connected to a supply source of the raw material gas GG through the raw material supply pipe 146. A discharge side of the blower 144 is connected to the wind box 142 through the raw material delivery pipe 148. The raw material gas GG supplied to the wind box 142 by the blower 144 is introduced into the storage tank 132 from the bottom surface (dispersion plate 142a) of the storage tank 132.

Therefore, the high-temperature catalyst particles CAT introduced from the cyclone 120 through the particle introduction port 132a are fluidized by the raw material gas GG, and a fluidized bed R (bubble fluidized bed) is formed in the storage tank 132. The thermal decomposition furnace 130 thermally decomposes the raw material gas GG by the heat of the fluidized bed R (catalyst particles CAT). That is, in the storage tank 132, the thermal decomposition reaction represented by the above formula (1) proceeds.

Thus, in the thermal decomposition furnace 130, a mixed gas MG containing hydrogen (H₂), unreacted methane (CH₄), carbon monoxide (CO), carbon dioxide (CO₂), and solid carbon (SC) is generated. The mixed gas MG generated in the thermal decomposition furnace 130 is introduced into the purification apparatus 150 through the first delivery port 132b and the first delivery pipe 134. The purification apparatus 150 separates hydrogen from the mixed gas MG. The purification apparatus 150 will be described in detail later.

On the other hand, as described above, the catalyst particles CAT fluidized in the thermal decomposition furnace 130 are returned to the heating furnace 110 through the particle discharge port 132c and the first pipe 112.

As described above, in the hydrogen production apparatus 100 according to the present embodiment, the catalyst particles CAT move through the heating furnace 110, the second pipe 114, the cyclone 120, the communication pipe 122, the thermal decomposition furnace 130 (storage tank 132), and the first pipe 112 in this order, and are introduced into the heating furnace 110 again, thereby circulating them.

The dust removal apparatus 160 is connected to an upper portion of the cyclone 120 through the third pipe 162. The dust removal apparatus 160 removes dust from the combustion exhaust gas EX. The dust removal apparatus 160 is, for example, a bag filter. The combustion exhaust gas EX from which dust is removed by the dust removal apparatus 160 is diffused to the atmosphere.

The oxidant supply unit 170 supplies air to the heating furnace 110. The oxidant supply unit 170 includes a blower 172 and an oxidant supply pipe 174. A suction side of the blower 172 is opened to the atmosphere. A discharge side of the blower 172 is connected to the oxidant supply pipe 174. The oxidant supply pipe 174 connects the blower 172 and a bottom of the heating furnace 110.

The first heat exchange unit 180 performs a heat exchange between the combustion exhaust gas EX (combustion exhaust gas EX passing through the third pipe 162) separated by the cyclone 120 and the air passing through the oxidant supply pipe 174. As a result, the heat is removed (cooled) from the combustion exhaust gas EX, and the air is heated. Thus, the cooled combustion exhaust gas EX is guided to the dust removal apparatus 160. The heated air is guided to the heating furnace 110 by the oxidant supply unit 170.

The fuel supply unit 190 supplies the fuel FG to the heating furnace 110. The fuel supply unit 190 will be described in detail later.

[Purification Apparatus 150]

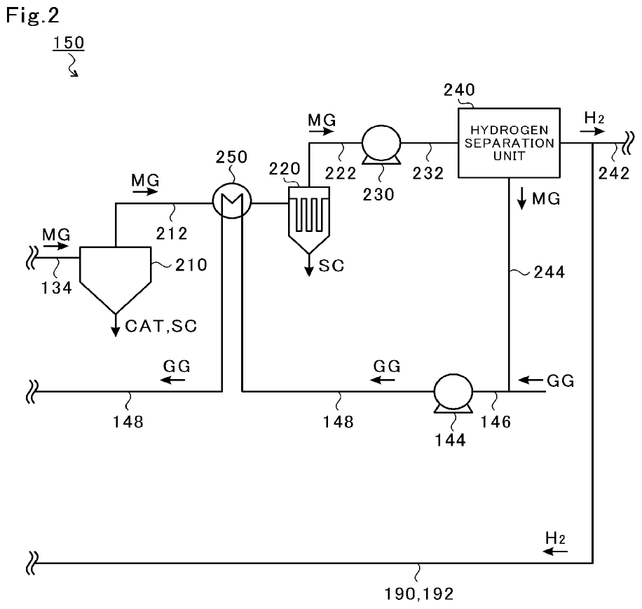

FIG. 2 is a view for explaining the purification apparatus 150 according to the first embodiment. As illustrated in FIG. 2, the purification apparatus 150 includes a cyclone 210, a fourth pipe 212, a carbon recovery unit 220, a fifth pipe 222, a compressor 230, a sixth pipe 232, a hydrogen separation unit 240, a seventh pipe 242, an eighth pipe 244, and a second heat exchange unit 250.

The cyclone 210 is connected to the first delivery port 132b of the storage tank 132 via the first delivery pipe 134. The cyclone 210 performs solid-gas separation of the mixed gas MG delivered from the storage tank 132 through the first delivery pipe 134. A solid material (catalyst particles CAT and solid carbon SC) separated by the cyclone 210 is used as a nanocarbon material or mixed with a structural material such as asphalt and concrete.

The fourth pipe 212 connects an upper portion of the cyclone 210 and the carbon recovery unit 220. The mixed gas MG after the solid material is separated by the cyclone 210 is guided to the carbon recovery unit 220 through the fourth pipe 212.

The carbon recovery unit 220 removes the solid carbon SC from the mixed gas MG. The carbon recovery unit 220 is, for example, a bag filter or a cyclone. The solid carbon SC removed by the carbon recovery unit 220 is conveyed to a solid carbon utilization facility in the subsequent stage.

The fifth pipe 222 connects the carbon recovery unit 220 and a suction side of the compressor 230. The compressor 230 increases the pressure of the mixed gas MG from which the solid carbon SC has been removed by the carbon recovery unit 220, and delivers the mixed gas MG to the hydrogen separation unit 240. The compressor 230 also functions as the fuel supply unit 190. The sixth pipe 232 connects a discharge side of the compressor 230 and the hydrogen separation unit 240.

The hydrogen separation unit 240 separates hydrogen from the mixed gas MG. The hydrogen separation unit 240 is, for example, an apparatus using pressure swing adsorption (PSA) or a cryogenic air separation apparatus.

The seventh pipe 242 connects the hydrogen separation unit 240 and a hydrogen utilization facility in the subsequent stage. Hydrogen (for example, the purity is 99% or more) separated by the hydrogen separation unit 240 is delivered to the hydrogen utilization facility.

The eighth pipe 244 connects the hydrogen separation unit 240 and the raw material supply pipe 146. The mixed gas MG after hydrogen is separated by the hydrogen separation unit 240 is mixed with the raw material gas GG guided from the supply source of the raw material gas and supplied to the storage tank 132. That is, the mixed gas MG after hydrogen is separated by the hydrogen separation unit 240 is guided as the raw material gas GG to the storage tank 132. The mixed gas MG after hydrogen is separated by the hydrogen separation unit 240 contains at least unreacted methane and hydrogen.

The fuel supply unit 190 includes the compressor 230 and a fuel supply pipe 192. The fuel supply pipe 192 connects the seventh pipe 242 and the heating furnace 110 (see FIG. 1). Therefore, in the present embodiment, the fuel supply unit 190 supplies, as the fuel FG, hydrogen separated by the hydrogen separation unit 240 to the heating furnace 110.

The second heat exchange unit 250 exchanges heat between the mixed gas MG subjected to solid-gas separation by the cyclone 210 and the raw material gas GG. In the present embodiment, the second heat exchange unit 250 exchanges heat between the mixed gas MG passing through the fourth pipe 212 and the raw material gas GG passing through the raw material delivery pipe 148. As a result, the heat is removed (cooled) from the mixed gas MG, and the raw material gas GG is heated. Thus, the mixed gas MG cooled is guided to the carbon recovery unit 220. The heated raw material gas GG is guided to the thermal decomposition furnace 130 (storage tank 132) by the raw material gas introduction unit 140.

As described above, the hydrogen production apparatus 100 according to the present embodiment includes the heating furnace 110 and the thermal decomposition furnace 130. Thus, the hydrogen production apparatus 100 can thermally decompose methane (hydrocarbon) by the heat of the catalyst particles CAT heated by the heating furnace 110.

In the hydrogen production apparatus 100, the heated catalyst particles CAT are introduced into the thermal decomposition furnace 130 (storage tank 132). Thus, the inside of the storage tank 132 is substantially uniformly heated by the catalyst particles CAT. Therefore, the hydrogen production apparatus 100 does not need to heat the thermal decomposition furnace 130 from the outside. As a result, the hydrogen production apparatus 100 does not need to constitute a furnace wall of the thermal decomposition furnace 130 with a material having heat resistance of 1000° C. or higher, and the production cost of the thermal decomposition furnace 130 can be reduced. Therefore, the hydrogen production apparatus 100 can thermally decompose methane (hydrocarbon) at low cost. In other words, the hydrogen production apparatus 100 can produce hydrogen at low cost.

In a conventional technique for heating the inside of the thermal decomposition furnace from the outside, it is difficult to equalize an internal temperature of the thermal decomposition furnace, and it is difficult to increase the size of the thermal decomposition furnace. On the other hand, the hydrogen production apparatus 100 can equalize the temperature in the storage tank 132 as compared with the conventional technique for heating the inside of the thermal decomposition furnace from the outside. As a result, the hydrogen production apparatus 100 can avoid a situation in which the temperature of the catalyst particles CAT locally decreases in the storage tank 132. Therefore, the hydrogen production apparatus 100 can efficiently thermally decompose methane (hydrocarbon). In addition, since the hydrogen production apparatus 100 can equalize the internal temperature of the storage tank 132, the storage tank 132 can be enlarged. Thus, the hydrogen production apparatus 100 can produce a large amount of hydrogen at low cost.

As described above, the raw material gas introduction unit 140 forms the fluidized bed R of the catalyst particles CAT in the storage tank 132. As a result, the thermal decomposition furnace 130 can slide the catalyst particles CAT in the storage tank 132. Therefore, the thermal decomposition furnace 130 can desorb the solid carbon SC grown on the surface of the catalyst particles CAT. Thus, in the hydrogen production apparatus 100, a dedicated apparatus (for example, a chemical cleaning apparatus) for separating the solid carbon SC from the catalyst particles CAT can be omitted.

As described above, the hydrogen production apparatus 100 includes the hydrogen separation unit 240 and the fuel supply unit 190. Thus, the hydrogen production apparatus 100 can burn hydrogen as the fuel FG to heat the catalyst particles CAT. Therefore, the hydrogen production apparatus 100 can prevent the generation of carbon dioxide in the heating of the catalyst particles CAT. Thus, the hydrogen production apparatus 100 can produce carbon dioxide-free hydrogen.

As described above, the hydrogen production apparatus 100 includes the first heat exchange unit 180, and the oxidant supply unit 170 supplies the air heated by the first heat exchange unit 180 to the heating furnace 110. That is, the hydrogen production apparatus 100 can preheat the air to be supplied to the heating furnace 110. Thus, the hydrogen production apparatus 100 can reduce the amount of the fuel FG necessary for heating the catalyst particles CAT to a desired temperature (for example, 900° C.). Therefore, the hydrogen production apparatus 100 can heat the catalyst particles CAT at low cost. The first heat exchange unit 180 can cool the combustion exhaust gas EX before being supplied to the dust removal apparatus 160. Therefore, the hydrogen production apparatus 100 can prevent the dust removal apparatus 160 from being damaged.

As described above, the hydrogen production apparatus 100 includes the second heat exchange unit 250, and the raw material gas introduction unit 140 introduces the raw material gas GG, heated by the second heat exchange unit 250, into the thermal decomposition furnace 130 (storage tank 132). That is, the hydrogen production apparatus 100 can preheat the raw material gas GG to be supplied to the thermal decomposition furnace 130. Thus, the hydrogen production apparatus 100 can suppress a decrease in the temperature of the thermal decomposition furnace 130. Therefore, the hydrogen production apparatus 100 can reduce a heating amount (amount of fuel FG) of the catalyst particles CAT in the heating furnace 110. In addition, the hydrogen production apparatus 100 can suppress non-uniformity of the temperature in the thermal decomposition furnace 130. Therefore, the hydrogen production apparatus 100 can efficiently thermally decompose methane (hydrocarbon). The second heat exchange unit 250 can cool the mixed gas MG before being supplied to the carbon recovery unit 220. Therefore, the hydrogen production apparatus 100 can prevent the carbon recovery unit 220 from being damaged.

[First Modification]

In the first embodiment, the configuration in which the fuel supply unit 190 supplies, as the fuel FG, hydrogen separated by the hydrogen separation unit 240 to the heating furnace 110 has been described as an example. However, the fuel supply unit may supply another gas as the fuel FG to the heating furnace 110.

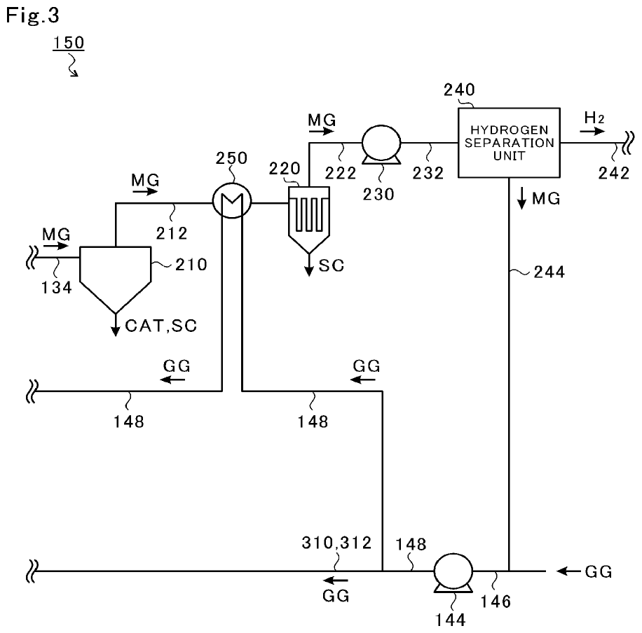

FIG. 3 is a view for explaining a fuel supply unit 310 according to the first modification. As illustrated in FIG. 3, the fuel supply unit 310 according to the first modification includes the compressor 230 and a fuel supply pipe 312. The fuel supply pipe 312 connects the raw material delivery pipe 148 and the heating furnace 110 (see FIG. 1). Therefore, in the first modification, the fuel supply unit 310 supplies, as the fuel FG, the mixed gas MG from which hydrogen has been removed by the hydrogen separation unit 240 to the heating furnace 110. The mixed gas MG from which hydrogen has been removed by the hydrogen separation unit 240 contains unreacted methane and hydrogen.

Unlike the first embodiment, the fuel supply unit 310 supplies the mixed gas MG to the heating furnace 110 instead of hydrogen. That is, unlike the first embodiment, the fuel supply unit 310 does not use hydrogen, produced by the hydrogen separation unit 240, for combustion in the heating furnace 110. Therefore, the fuel supply unit 310 can increase a production amount of hydrogen per unit raw material gas GG amount as compared with the first embodiment. Therefore, the hydrogen production apparatus 100 including the fuel supply unit 310 can produce hydrogen at low cost.

[Second Modification]

In the first embodiment and the first modification, the configuration in which the fuel supply units 190 and 310 supply, as the fuel FG, hydrogen or the mixed gas MG separated by the hydrogen separation unit 240 to the heating furnace 110 has been described as an example. However, the fuel supply unit may supply another gas as the fuel FG to the heating furnace 110.

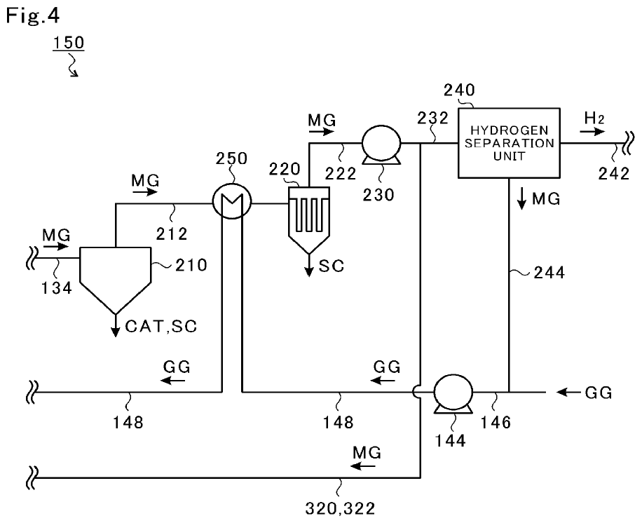

FIG. 4 is a view for explaining a fuel supply unit 320 according to the second modification. As illustrated in FIG. 4, the fuel supply unit 320 according to the second modification includes the compressor 230 and a fuel supply pipe 322. The fuel supply pipe 322 connects the sixth pipe 232 and the heating furnace 110 (see FIG. 1). Therefore, in the second modification, the fuel supply unit 320 supplies, as fuel, the mixed gas MG from which the solid carbon has been removed by the carbon recovery unit 220 to the heating furnace 110. The mixed gas MG from which the solid carbon has been removed by the carbon recovery unit 220 contains unreacted methane and hydrogen.

As a result, the fuel supply unit 320 can reduce the amount of the mixed gas MG guided to the hydrogen separation unit 240 as compared with the first embodiment. This makes it possible to reduce a hydrogen separation power of the hydrogen separation unit 240. A main component of the mixed gas MG guided to the hydrogen separation unit 240 is hydrogen. Thus, when the mixed gas MG is used as the fuel FG by the fuel supply unit 320, it is possible to reduce the amount of carbon dioxide generated as compared with the case of using hydrocarbon as the fuel FG.

[Third Modification]

In the first embodiment, the configuration in which the loop seal is provided in the first pipe 112 and the communication pipe 122 has been described as an example. However, the loop seal may be omitted.

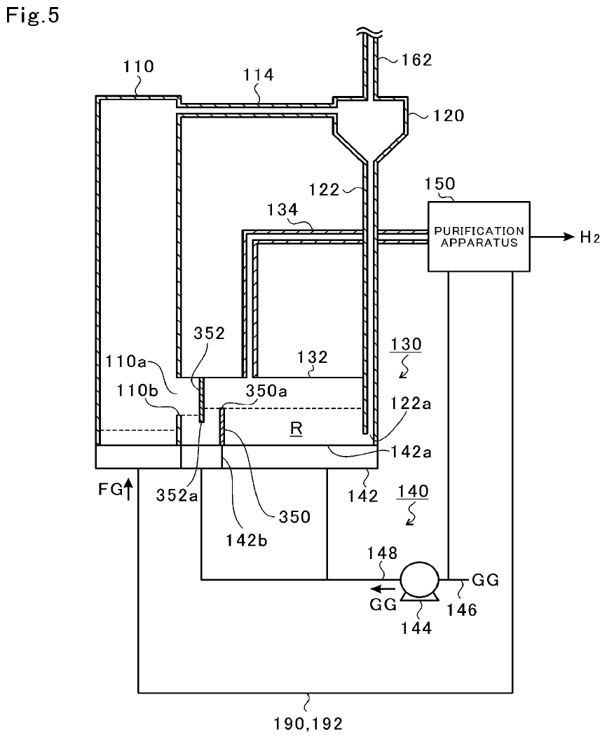

FIG. 5 is a view for explaining the heating furnace 110, the cyclone 120, and the thermal decomposition furnace 130 according to the third modification. In FIG. 5, a broken line indicates an upper surface of the fluidized bed R of the catalyst particles CAT.

As illustrated in FIG. 5, in the third modification, the communication pipe 122 penetrates through the upper surface of the storage tank 132 and extends to the inside of the storage tank 132. A lower opening 122a of the communication pipe 122 is located in the fluidized bed R formed in the storage tank 132.

The side surface of the storage tank 132 and the side surface of the heating furnace 110 communicate with each other through the opening 110a.

In the storage tank 132, a first partition plate 350 and a second partition plate 352 are provided. The first partition plate 350 is a plate extending (placed upright) in a vertical direction from the dispersion plate 142a to an upper end 350a and extending over both side surfaces. The upper end 350a (distal end) of the first partition plate 350 is separated from the upper surface of the storage tank 132. In the third modification, the first delivery pipe 134 is connected between the communication pipe 122 and the first partition plate 350 on the upper surface of the storage tank 132.

The second partition plate 352 is provided between the first partition plate 350 and the opening 110a. The second partition plate 352 is a plate extending in the vertical direction from the upper surface to a lower end 352a of the storage tank 132 and extending over both side surfaces. The lower end 352a (distal end) of the second partition plate 352 is separated from the dispersion plate 142a.

The upper end 350a of the first partition plate 350 is located above the lower end 352a of the second partition plate 352. The lower end 352a of the second partition plate 352 is located below a lower end 110b of the opening 110a. The lower end 110b of the opening 110a is located below the upper end 350a of the first partition plate 350.

A third partition plate 142b is provided in the wind box 142 of the third modification. The third partition plate 142b is provided at a position corresponding to the first partition plate 350 in the wind box 142. The third partition plate 142b partitions the inside of the wind box 142 such that the raw material gas GG cannot flow or cannot flow easily. The raw material delivery pipe 148 is connected between the communication pipe 122 and the first partition plate 350 in the wind box 142 and between the first partition plate 350 and the opening 110a.

As described above, the communication pipe 122 according to the third modification penetrates through the upper surface of the storage tank 132 and extends to the inside of the storage tank 132. As a result, in the third modification, it is possible to avoid a situation in which the combustion exhaust gas EX of the third pipe 162 is mixed into the storage tank 132. Thus, unlike the first embodiment, the communication pipe 122 of the third modification can omit the loop seal.

The heating furnace 110 and the thermal decomposition furnace 130 according to the third modification include the opening 110a, the first partition plate 350, and the second partition plate 352. As a result, in the third modification, it is possible to avoid a situation in which the mixed gas MG of the storage tank 132 is mixed into the heating furnace 110. Thus, unlike the first embodiment, the heating furnace 110 and the thermal decomposition furnace 130 can omit the first pipe 112 and the loop seal.

Thus, in the third modification, the loop seal and the equipment associated with the loop seal can be omitted. Thus, in the third modification, the entire hydrogen production apparatus 100 can be made compact, and the cost of the hydrogen production apparatus 100 can be reduced.

### Second Embodiment: Hydrogen Production Apparatus 400

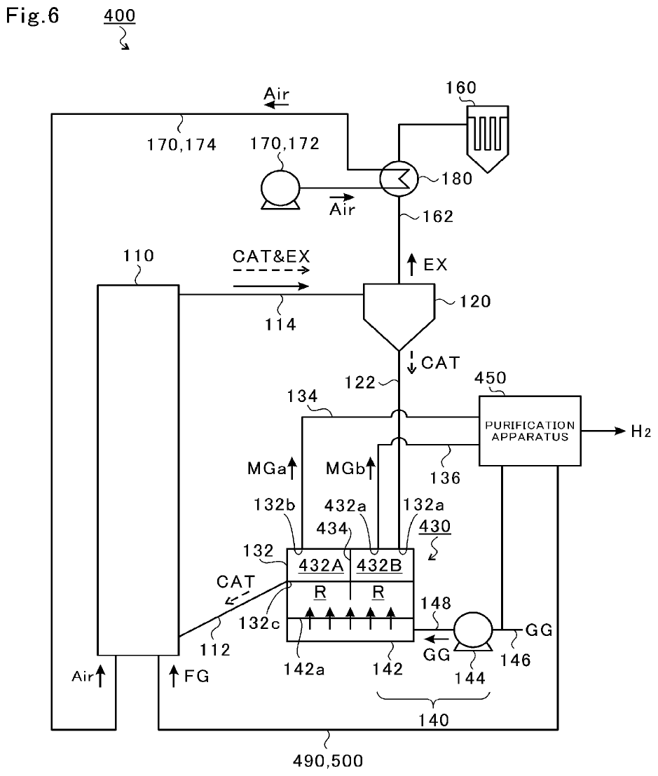

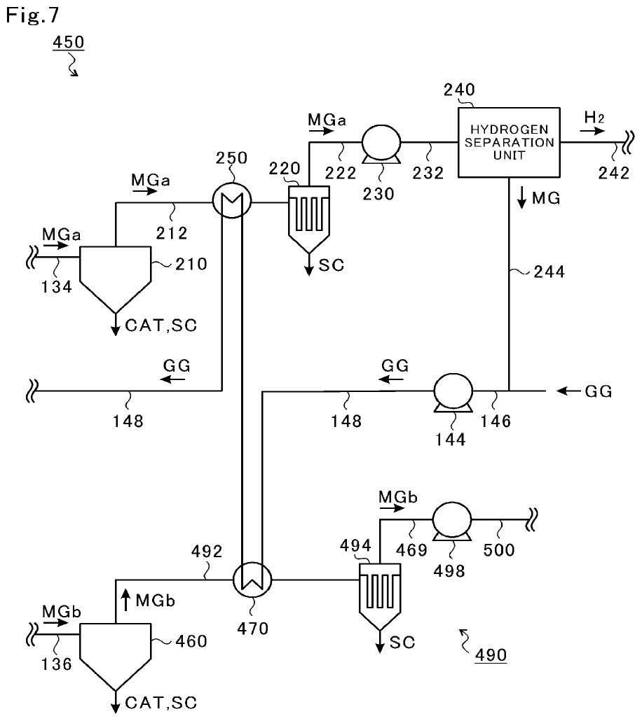

FIG. 6 is a view for explaining a hydrogen production apparatus 400 according to a second embodiment. FIG. 7 is a view for explaining a purification apparatus 450 according to the second embodiment. As illustrated in FIG. 6, the hydrogen production apparatus 400 includes a heating furnace 110, a first pipe 112, a second pipe 114, a cyclone 120, a communication pipe 122, a thermal decomposition furnace 430, a first delivery pipe 134, a second delivery pipe 136, the purification apparatus 450, a dust removal apparatus 160, a third pipe 162, an oxidant supply unit 170, a first heat exchange unit 180, and a fuel supply unit 490. As illustrated in FIG. 7, the purification apparatus 450 includes a cyclone 210, a fourth pipe 212, a carbon recovery unit 220, a fifth pipe 222, a compressor 230, a sixth pipe 232, a hydrogen separation unit 240, a seventh pipe 242, an eighth pipe 244, a second heat exchange unit 250, a cyclone 460, and a second heat exchange unit 470.

In FIGS. 6 and 7, solid arrows indicate a flow of gas. In FIG. 6, a broken line arrow indicates a flow of catalyst particles CAT. Constituent elements that are substantially equal to those of the above-mentioned hydrogen production apparatus 100 are denoted by the same reference symbols as those therein, and description thereof is omitted.

The thermal decomposition furnace 430 includes a storage tank 132, a partition plate 434, and a raw material gas introduction unit 140. On an upper surface of the storage tank 132, a particle introduction port 132a, a first delivery port 132b, and a second delivery port 432a are provided. The second delivery port 432a is provided between the particle introduction port 132a and the first delivery port 132b. That is, the second delivery port 432a is provided downstream of the particle introduction port 132a in the flow direction of the catalyst particles CAT. Furthermore, the second delivery port 432a is provided upstream of the first delivery port 132b in the flow direction of the catalyst particles CAT. The second delivery pipe 136 is connected to the second delivery port 432a.

The partition plate 434 is provided in the storage tank 132. The partition plate 434 is a plate extending in the vertical direction from the upper surface to a lower end of the storage tank 132 and extending over both side surfaces. The lower end (distal end) of the partition plate 434 is separated from the dispersion plate 142a (bottom). The partition plate 434 partitions the inside of the storage tank 132 into a first chamber 432A in which the first delivery port 132b is provided and a second chamber 432B in which the particle introduction port 132a and the second delivery port 432a are provided.

During the operation of the hydrogen production apparatus 100, the lower end of the partition plate 434 is located in a fluidized bed R formed of the catalyst particles CAT. That is, the partition plate 434 divides a freeboard region formed in the storage tank 132 into two regions.

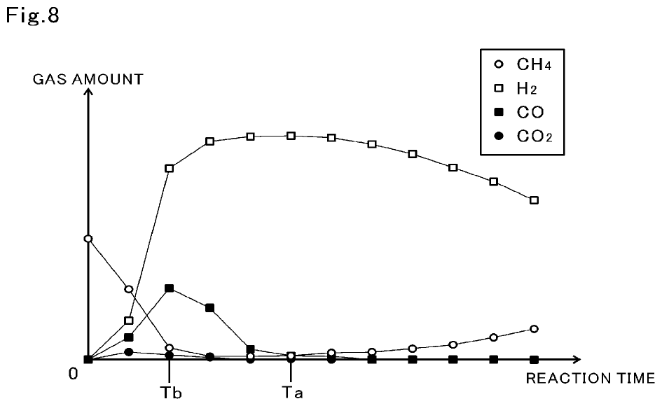

FIG. 8 is a view for explaining a relationship between a reaction time in which methane as a raw material gas GG is passed through the catalyst particles CAT and a gas generation amount in the storage tank 132. In FIG. 8, the horizontal axis represents a lapse of the reaction time of methane decomposition. In FIG. 8, the vertical axis represents the gas generation amount in the storage tank 132. In FIG. 8, white circles indicate methane. In FIG. 8, white squares represent hydrogen. In FIG. 8, black squares indicate carbon monoxide. In FIG. 8, black circles indicate carbon dioxide.

As illustrated in FIG. 8, methane decreases with the progress of the thermal decomposition reaction until a residence time of the catalyst particles CAT reaches a time Ta. Methane slightly gradually increases when the residence time of the catalyst particles CAT exceeds the time Ta. On the other hand, a hydrogen generation amount increases with the progress of the thermal decomposition reaction of methane until the residence time of the catalyst particles CAT reaches the time Ta. Furthermore, the hydrogen generation amount slightly gradually decreases beyond the time Ta.

A carbon monoxide generation amount increases until the residence time of the catalyst particles CAT reaches a time Tb shorter than the time Ta, and gradually decreases after the time Tb. Furthermore, the carbon monoxide generation amount is about 0 when the time exceeds the time Ta. In a carbon dioxide generation amount, although carbon dioxide is slightly generated until the residence time of the catalyst particles CAT reaches the time Tb, when the time exceeds the time Ta, the carbon dioxide generation amount is about 0. That is, as illustrated in FIG. 8, it is found that carbon monoxide and carbon dioxide are generated before the residence time of the catalyst particles CAT reaches the time Ta.

In the heating furnace 110, at least some of the catalyst particles CAT is oxidized by oxygen contained in air used for burning the fuel FG, and the oxidized catalyst particles CAT are guided to the thermal decomposition furnace 130. Thus, the catalyst particles CAT oxidized in the thermal decomposition furnace 130 are reduced by methane, and carbon monoxide and carbon dioxide are generated.

As described above, the catalyst particles CAT are guided into the storage tank 132 through the particle introduction port 132a, and discharged from the storage tank 132 through the particle discharge port 132c. That is, the catalyst particles CAT move in the storage tank 132 from the right side to the left side in FIG. 6. Thus, the partition plate 434 is installed at a position in the storage tank 132 that corresponds to a predetermined time during which the residence time of the catalyst particles CAT is equal to or longer than the time Ta.

Thus, in the second chamber 432B, the partition plate 434 can restrict movement of a mixed gas MGb containing carbon monoxide and carbon dioxide, which is generated by reduction of the catalyst particles CAT, to the first chamber 432A.

In the second chamber 432B, the reduced catalyst particles CAT pass under the partition plate 434 and move to the first chamber 432A. Thus, the thermal decomposition furnace 430 can generate a mixed gas MGa containing hydrogen and methane in the first chamber 432A.

Thus, the mixed gas MGb containing methane, hydrogen, carbon monoxide, and carbon dioxide, which is generated in the second chamber 432B, is delivered to the cyclone 460 through the second delivery port 432a and the second delivery pipe 136. On the other hand, the mixed gas MGa containing methane and hydrogen generated in the first chamber 432A is delivered to the cyclone 210 through the first delivery port 132b and the first delivery pipe 134.

As illustrated in FIG. 7, the cyclone 460 is connected to the second delivery port 432a of the storage tank 132 via the second delivery pipe 136. The cyclone 460 performs solid-gas separation of the mixed gas MGb delivered from the storage tank 132 through the second delivery pipe 136. A solid material (catalyst particles CAT and solid carbon SC) separated by the cyclone 460 is used as a nanocarbon material or mixed with a structural material such as asphalt and concrete.

The fuel supply unit 490 includes a ninth pipe 492, a carbon recovery unit 494, a tenth pipe 496, a blower 498, and a fuel supply pipe 500.

The ninth pipe 492 connects an upper portion of the cyclone 460 and the carbon recovery unit 494. The mixed gas MGb after the solid material is separated by the cyclone 460 is guided to the carbon recovery unit 494 through the ninth pipe 492.

The carbon recovery unit 494 removes the solid carbon SC from the mixed gas MGb. The carbon recovery unit 494 is, for example, a bag filter or a cyclone. The solid carbon SC removed by the carbon recovery unit 494 is conveyed to a solid carbon utilization facility in the subsequent stage.

The tenth pipe 496 connects the carbon recovery unit 494 and a suction side of the blower 498. The blower 498 increases the pressure of the mixed gas MGb from which the solid carbon SC has been removed by the carbon recovery unit 494, and delivers the mixed gas MGb to the heating furnace 110. The fuel supply pipe 500 connects a discharge side of the blower 498 and the heating furnace 110.

Therefore, in the present embodiment, the fuel supply unit 490 supplies, as the fuel FG, the mixed gas MGb separated by the cyclone 460 to the heating furnace 110.

The second heat exchange unit 470 exchanges heat between the mixed gas MGb passing through the ninth pipe 492 and the raw material gas GG passing through the raw material delivery pipe 148. Then, the second heat exchange unit 250 exchanges heat between the raw material gas GG heated by the second heat exchange unit 470 and the mixed gas MGa passing through the fourth pipe 212.

As described above, the hydrogen production apparatus 400 according to the present embodiment includes the partition plate 434 and the second delivery pipe 136. Thus, the hydrogen production apparatus 400 can separate carbon monoxide and carbon dioxide, generated by the reduction of the catalyst particles CAT, from the mixed gas MGa. Therefore, the hydrogen production apparatus 400 can increase a hydrogen concentration in the mixed gas MGa guided to the hydrogen separation unit 240. Thus, in the hydrogen production apparatus 400, the hydrogen separation unit 240 can be downsized. As a result, the hydrogen production apparatus 400 can reduce the cost of the hydrogen separation unit 240. Therefore, the hydrogen production apparatus 400 can produce hydrogen at low cost.

The embodiments have been described above with reference to the attached drawings, but, needless to say, the present disclosure is not limited to the embodiments. It is apparent that those skilled in the art may arrive at various alternations and modifications within the scope of claims, and those examples are construed as naturally falling within the technical scope of the present disclosure.

For example, in the first embodiment described above, the configuration in which the fuel supply unit 190 supplies only hydrogen as the fuel FG to the heating furnace 110 has been described as an example. However, the fuel supply unit 190 may supply hydrocarbon as the fuel FG to the heating furnace 110 in addition to hydrogen.

In the first embodiment, the first modification, the second modification, and the second embodiment, the configuration in which the oxidant supply unit 170 supplies air to the heating furnace 110 has been described as an example. However, the oxidant supply unit 170 may supply an oxidant to the heating furnace 110. For example, the oxidant supply unit 170 may supply an oxygen-enriched gas to the heating furnace 110.

In the first embodiment, the first modification, the second modification, and the second embodiment, the configuration in which the hydrogen production apparatuses 100 and 400 include the first heat exchange unit 180 has been described as an example. However, the first heat exchange unit 180 is not an essential component. Similarly, in the first embodiment, the first modification, the second modification, and the second embodiment, the configuration in which the hydrogen production apparatuses 100 and 400 include the second heat exchange unit 250 has been described as an example. However, the second heat exchange unit 250 is not an essential component. In the second embodiment, the configuration in which the hydrogen production apparatus 400 includes the second heat exchange unit 470 has been described as an example. However, the second heat exchange unit 470 is not an essential component.

In the second embodiment, the case where the thermal decomposition furnace 430 includes the partition plate 434 has been described as an example. However, the partition plate 434 is not an essential component.

In the second embodiment, the case where the inside of one storage tank 132 is partitioned into two regions by the partition plate 434 has been described as an example. However, two storage tanks 132 may be provided. In this case, the first delivery pipe 134 and the first pipe 112 are connected to a first storage tank 132. The communication pipe 122 and the second delivery pipe 136 are connected to a second storage tank 132. A pipe and a loop seal connecting a side surface of the first storage tank 132 and a side surface of the second storage tank 132 are provided. That is, the first storage tank 132 functions as the first chamber 432A, and the second storage tank 132 functions as the second chamber 432B.

In the second embodiment, the configuration in which the second heat exchange unit 250 performs heat exchange of the raw material gas GG after heat exchange by the second heat exchange unit 470 has been described as an example. However, the second heat exchange unit 470 may perform heat exchange of the raw material gas GG after heat exchange by the second heat exchange unit 250.

The fuel supply unit may supply, as fuel, two or more kinds of gases of hydrogen separated by the hydrogen separation unit 240, the mixed gas after hydrogen separation by the hydrogen separation unit 240, the mixed gas from which the solid carbon has been removed by the carbon recovery unit 220, and the mixed gas delivered from the storage tank 132 through the second delivery port 432a to the heating furnace 110.

In the hydrogen production apparatuses 100 and 400, a soot blower or an apparatus that supplies a jet of gas may be included in the storage tank 132. As a result, the solid carbon SC can be efficiently desorbed from the catalyst particles CAT.

As described above, along with the flows of the mixed gases MG, MGa, and MGb, some of the catalyst particles CAT are delivered from the thermal decomposition furnace 130. Thus, the catalyst particles CAT may be appropriately added to the hydrogen production apparatus 100. Preferably, the catalyst particles CAT are added into the storage tank 132 through the heating furnace 110, the first pipe 112, the second pipe 114, the cyclone 120, and the communication pipe 122. Thus, the new catalyst particles CAT can be efficiently heated. Therefore, it is possible to avoid a situation in which the new catalyst particles CAT at about normal temperature are supplied to the storage tank 132. Thus, it is possible to avoid suppression of the thermal decomposition reaction by the new catalyst particles CAT at about normal temperature.

What is claimed is:

1. A hydrogen production apparatus comprising:
a heating furnace that burns fuel supplied by a fuel supply unit and heats catalyst particles;
a cyclone that is connected to a downstream side of the heating furnace and separates the catalyst particles and a combustion exhaust gas; and
a thermal decomposition furnace including a storage tank that stores the catalyst particles separated by the cyclone and a raw material gas introduction unit that introduces a raw material gas containing at least hydrocarbon from a lower portion of the storage tank.

2. The hydrogen production apparatus according to claim 1, further comprising a hydrogen separation unit that separates hydrogen from a mixed gas delivered from the storage tank,
wherein the fuel supply unit supplies, as the fuel, the hydrogen separated by the hydrogen separation unit to the heating furnace.

3. The hydrogen production apparatus according to claim 1, further comprising a hydrogen separation unit that separates hydrogen from a mixed gas delivered from the storage tank,
wherein the fuel supply unit supplies, as the fuel, the mixed gas obtained after the hydrogen is separated by the hydrogen separation unit to the heating furnace.

4. The hydrogen production apparatus according to claim 1, further comprising a carbon recovery unit that removes solid carbon from the mixed gas delivered from the storage tank,
wherein the fuel supply unit supplies, as the fuel, the mixed gas from which the solid carbon has been removed to the heating furnace.

5. The hydrogen production apparatus according to claim 1,
wherein the storage tank includes a particle introduction port through which the catalyst particles separated by the cyclone are guided,
a first delivery port through which the mixed gas generated in the storage tank is delivered, and
a second delivery port which is provided between the particle introduction port and the first delivery port and through which the mixed gas generated in the storage tank is delivered, and
the fuel supply unit supplies, as the fuel, the mixed gas delivered from the storage tank to the heating furnace through the second delivery port.

6. The hydrogen production apparatus according to claim 5, further comprising a partition plate which is provided in the storage tank and partitions an inside of the storage tank into a first chamber in which the first delivery port is provided and a second chamber in which the second delivery port is provided.

7. The hydrogen production apparatus according to claim 1, further comprising:
a first heat exchange unit that exchanges heat between the combustion exhaust gas separated by the cyclone and an oxidant; and
an oxidant supply unit that supplies the oxidant heat-exchanged by the first heat exchange unit to the heating furnace.

8. The hydrogen production apparatus according to claim 1, further comprising a second heat exchange unit that exchanges heat between the mixed gas delivered from the storage tank and the raw material gas,
wherein the raw material gas introduction unit introduces the raw material gas heat-exchanged by the second heat exchange unit into the storage tank.
